(19) United States
(12) Patent Application Publication
(10) Pub. No.: US 2024/0220943 A1
(43) Pub. Date: Jul. 4, 2024

(54) System and Method for Providing Membership Services for Automotive Repairs

(71) Applicant: Nelson Sua, Honolulu, HI (US)

(72) Inventor: Nelson Sua, Honolulu, HI (US)

(21) Appl. No.: 18/401,029

(22) Filed: Dec. 29, 2023

Related U.S. Application Data
(60) Provisional application No. 63/477,771, filed on Dec. 29, 2022.

(51) Int. Cl. G06Q 10/20; G06Q 50/40

(52) U.S. Cl. CPC G06Q 10/20; G06Q 50/40

(57) ABSTRACT

Disclosed herein is a system and a method for providing membership services for automotive repairs. The system and method comprise steps of providing a first screen configured to allow a user to sign into an existing user account or to create a user account; providing a second screen configured to allow user to select a membership package if the user choose to create the user account; providing a third screen configured to input personal information, in response to the user selecting a membership package; providing a fourth screen configured to input the automobile information after receiving the personal information; transmitting to the server, the personal information and the automobile information after receiving the personal information and the automobile information; and storing the personal information and the automobile information the user account for future retrieval by the user or other authorized users.

### FIELD OF THE INVENTION

The present invention relates generally to membership services and the automotive repair industry. More specifically, the present invention provides a unique membership platform for maintenance and repair of automobiles at affordable prices.

### BACKGROUND OF THE INVENTION

Nowadays, the automotive repair and maintenance industry has many issues. One of the major issues is that labor and parts costs are too expensive for many people. Depending on the repairs or maintenance needed, labor costs can be greater than the parts costs which often results in an expensive repair for small repairs. In addition, many companies in the industry do not have open transparency regarding costs involved in the repair process that drive the repair costs even higher. This does not help with public trust and can cause further issues such as utilizing inappropriate parts or repair services to avoid paying for high repair costs. Therefore, there is a need for a better methodology that enables automobile owners to repair their automobiles in better, cheaper, and more efficient manner.

An objective of the present invention is to provide a system and a method for providing membership services for automotive repairs. The present invention is a unique method that brings trust, fair pricing, and extra services that save time and money for customers. Another objective of the present invention is to provide several membership services that cater the different needs of customers. The present invention provides various memberships plans online or through traditional methods. Another objective of the present invention is to provide a credit system that compensates the user for the use of the different memberships. Additional features and benefits of the present invention are further discussed in the sections below.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present invention is a system and a method for providing membership services for automotive repairs. The present invention includes a software application that enables the user to access the services of the present invention. Further, the present invention includes out-of-the-box automotive services and enables the creation of a vehicle membership program. The membership services of the present invention offer various services including, but not limited to, 24-hour vehicle pickup, shop visits, shop free hours, free engine & transmission replacement, discounts, etc. Further, the software application of the present invention enables the user to book appointments, view service logs, access a virtual automotive concierge, provide instant review, tip a technician, view the repair process real-time, request roadside assistance, etc. The different features can be grouped into different tiers that can be chosen by the user.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a schematic view of a home page of the software application of the present invention.

FIG. 3 is a schematic view of a registration page of the software application of the present invention.

FIG. 4 is a schematic view of a registration page of the software application of the present invention, wherein the user is prompted to choose a membership package.

FIG. 5 is a schematic view of a dashboard page of the software application of the present invention.

FIG. 6 is a schematic view of a services page of the software application of the present invention.

FIG. 7 is a schematic view of a services page of the software application of the present invention, wherein the user is prompted to select a type of emergency to request roadside assistance.

FIG. 8 is a schematic view of a services page of the software application of the present invention, wherein the user is provided with updates of the roadside assistance request.

FIG. 9 is a schematic view of a services page of the software application of the present invention, wherein the user is prompted to select a vehicle to request tracking services.

FIG. 10 is a schematic view of a services page of the software application of the present invention, wherein the vehicle location is display on the computing device.

FIG. 11 is a flowchart illustrating the login process of the present invention.

FIG. 12 is a flowchart illustrating the registration process of the present invention.

FIG. 13 is a flowchart illustrating the roadside assistance request process of the present invention.

FIG. 14 is a block diagram of a computing device for implementing the methods disclosed herein, in accordance with some embodiments.

### DETAIL DESCRIPTIONS OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

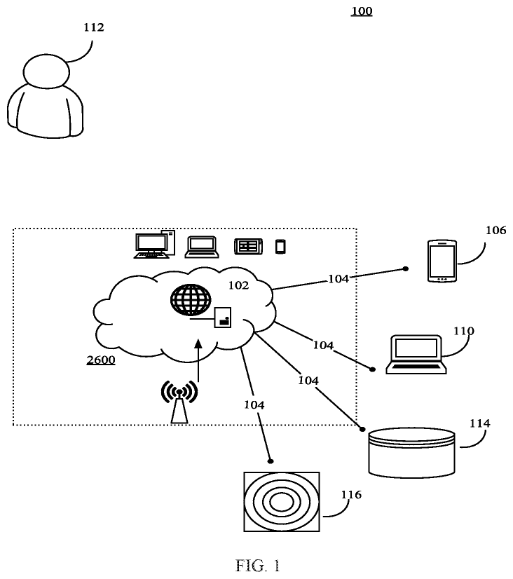

FIG. 1 is an illustration of an online platform 100 consistent with various embodiments of the present disclosure. By way of non-limiting example, the online platform 100 configured to provide membership services for automotive repairs may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but not limited to, the Internet. Further, the databases 114 may be associated with government agencies. Further, users of the online platform 100 may include relevant parties such as, but not limited to, end-users, administrators, service providers, service consumers, and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 2600.

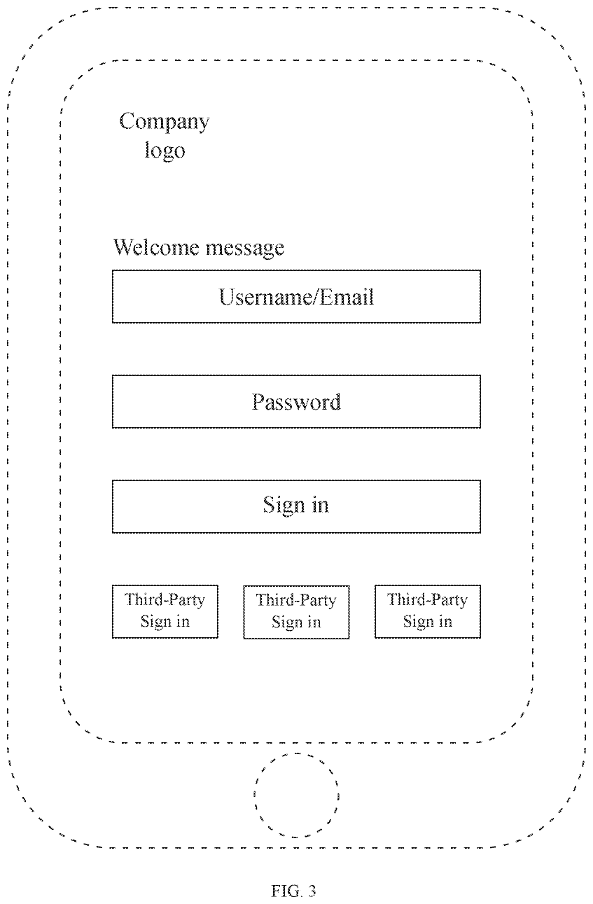

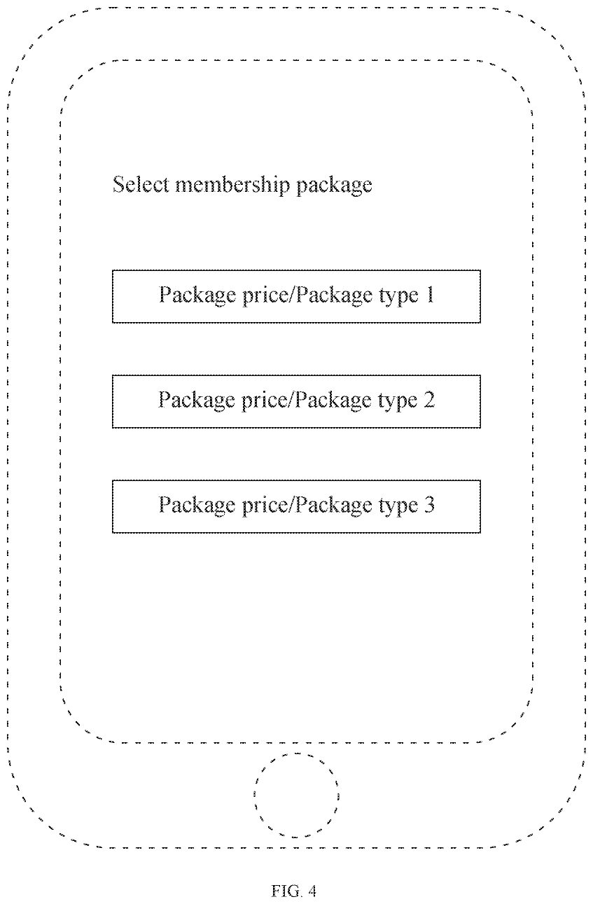

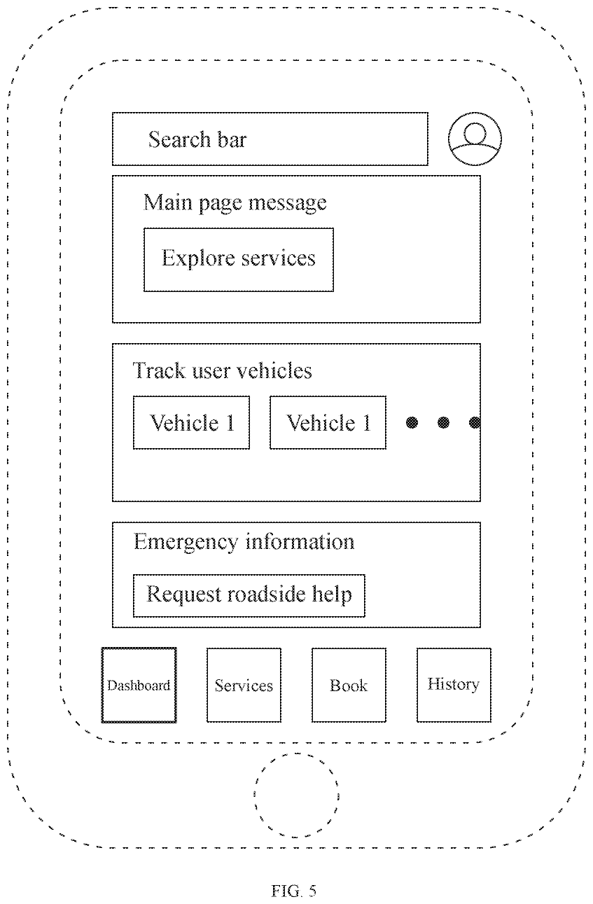

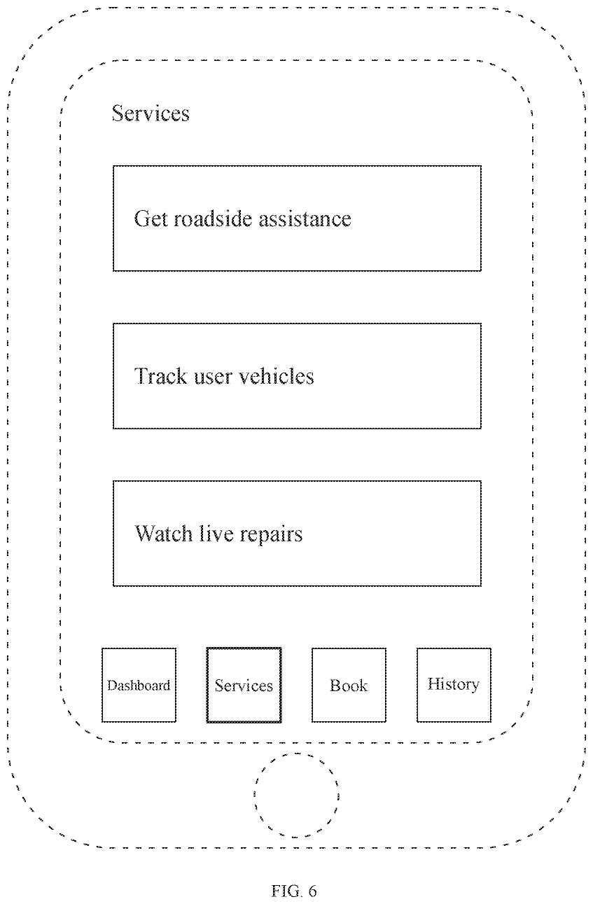

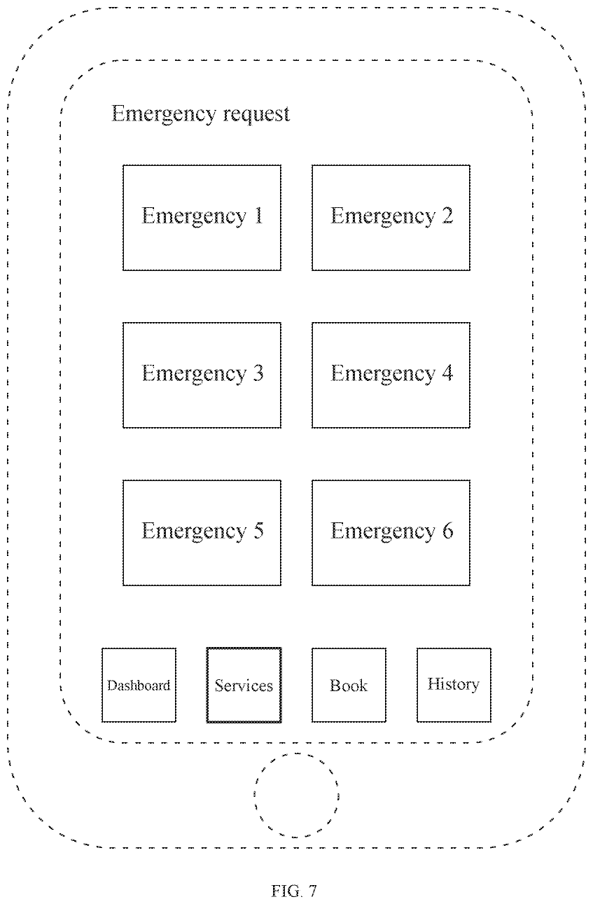

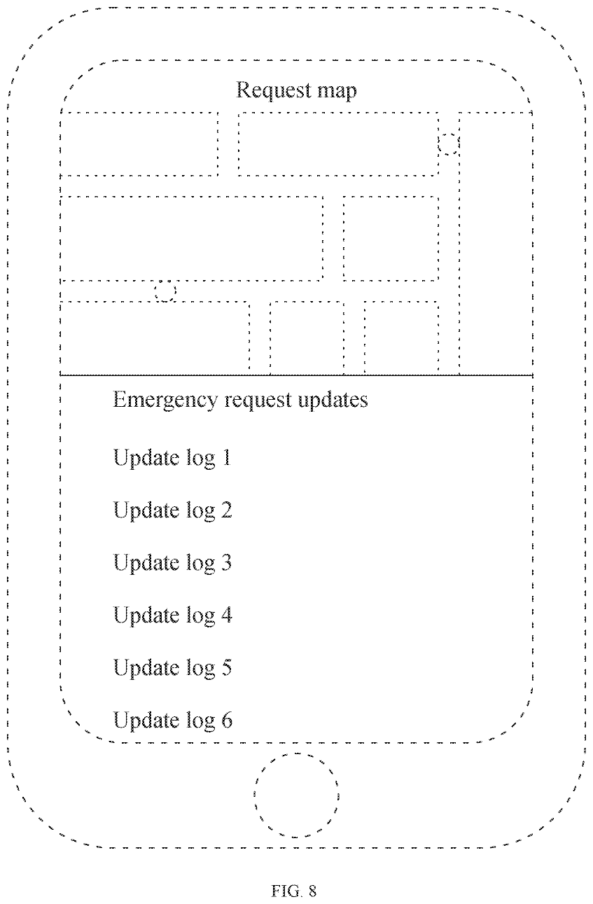

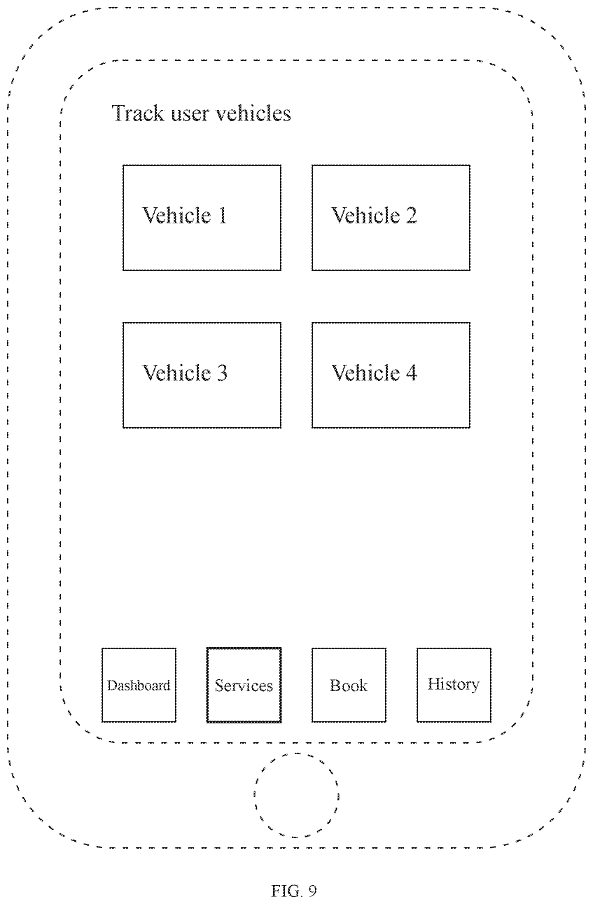

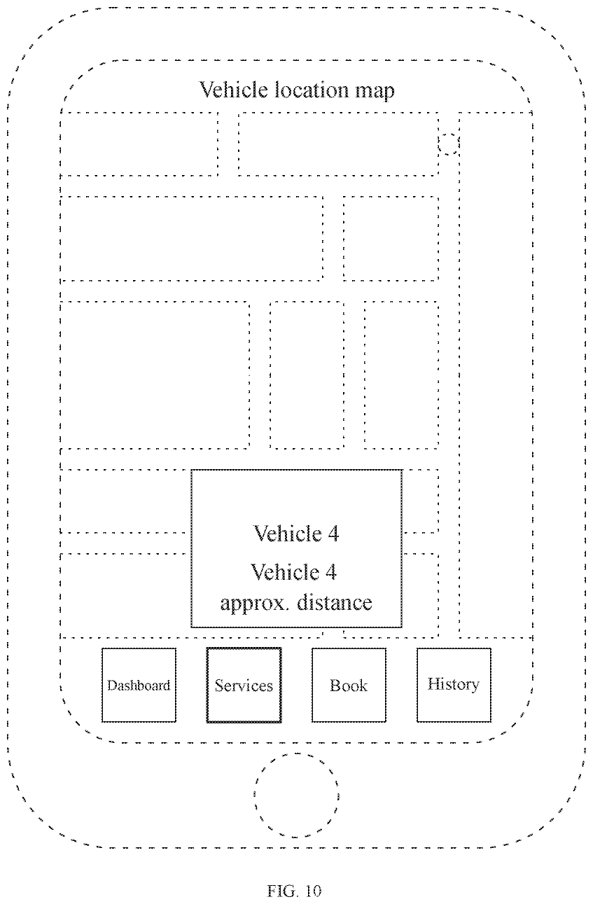

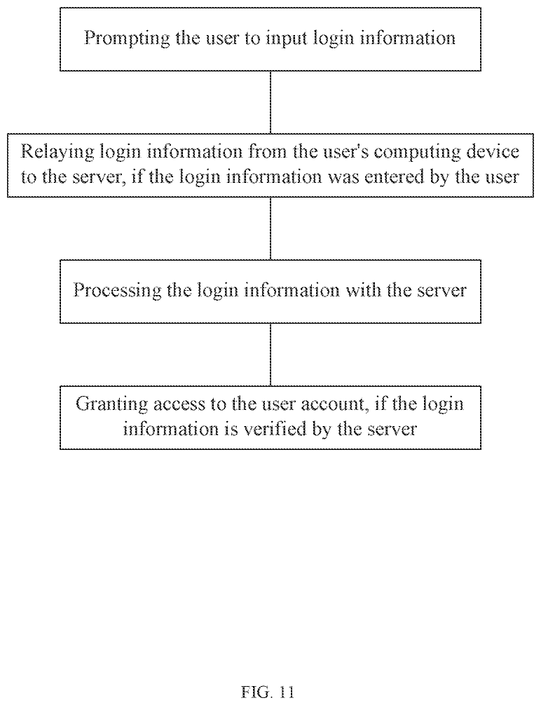

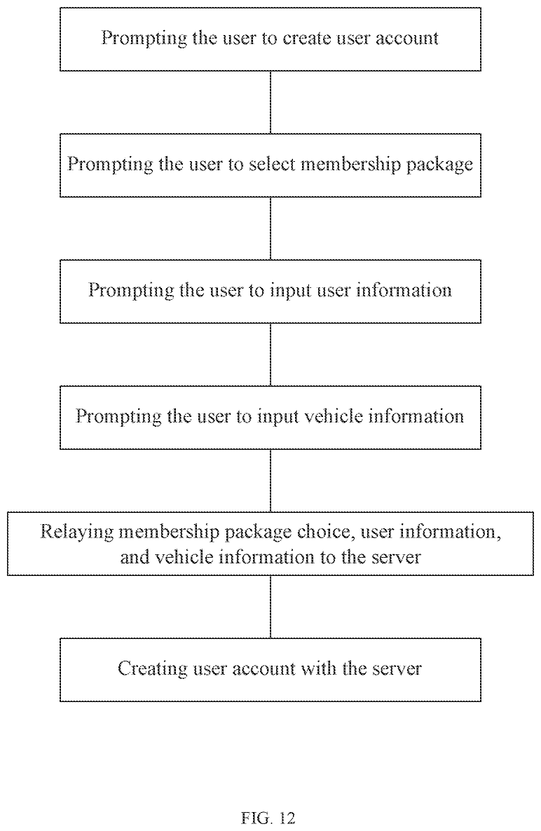

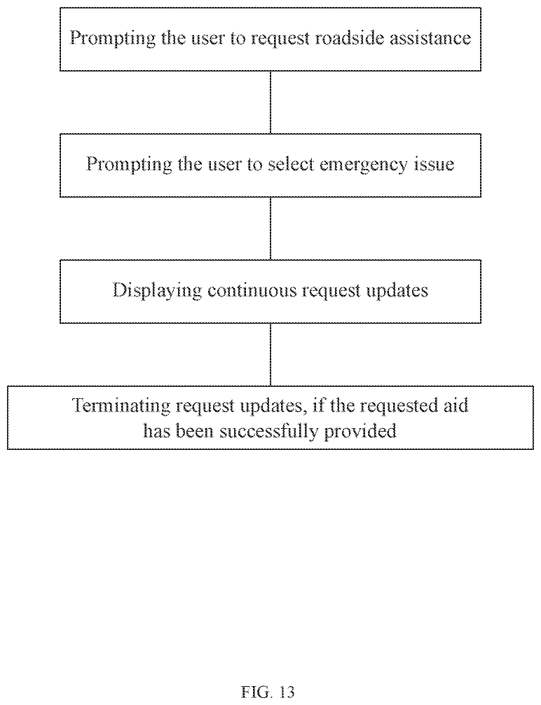

The present invention is a system and a method for providing membership services for automotive repairs. As can be seen in FIG. 1 through 14, the present invention provides the user with quick and expectational service at every visit. The present invention implements a gas-and-go approach to all automobile services and plans. In the preferred embodiment, the present invention provides the user with different membership options for automobile maintenance and repair. The present invention also utilizes various maintenance and repair subsidiaries to manage all automobile needs. This ensures that the automobile is always running at optimal performance while significantly minimizing future breakdowns. In addition, the present invention provides credit system, preferably referred to Repair and Maintenance (RAM) credits that serve as an extra money-saving source for the user. RAM credits offer the user discounted rate packages on shop labor hours. In other words, the more the user purchases, the cheaper the shop rate becomes. Moreover, RAM credits are transferable and can be applied to family members, friends, etc.

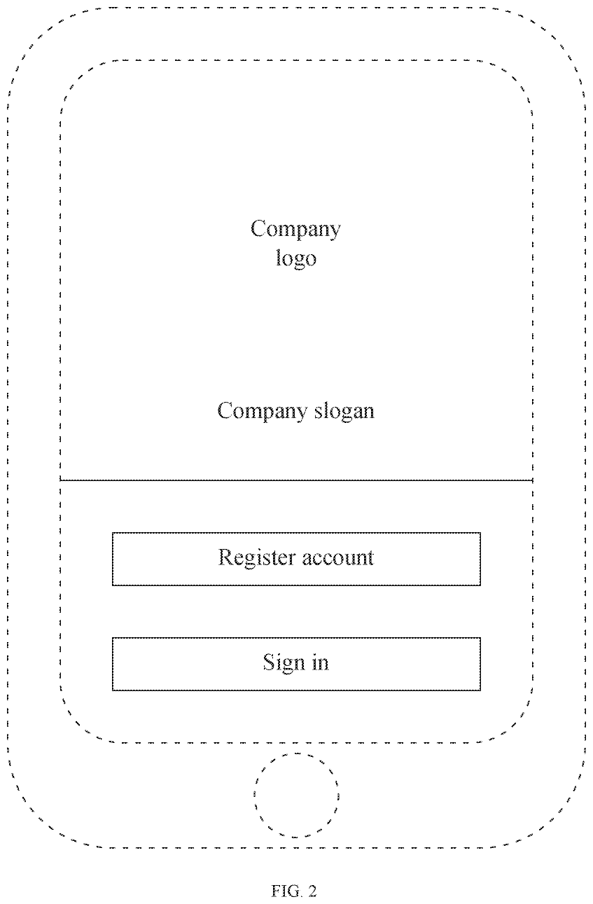

In the preferred embodiment, the present invention provides a software application that enables users to access the different features of the platform. As can be seen in FIG. 2 through 13, the software application can be implemented to operate in several computing devices including, but not limited to, smartphones, tablet computers, laptops, desktop computers, etc. Depending on the computing device on which the software application is installed, the software application of the present invention can be programmed to operate with the different features of the computing device such as, but not limited to, the device's user interface, the device's camera, etc. Further, the software application can be implemented to operate with third-party applications or service providers including, but not limited to, web browsers, search engines, etc. For example, the software application can be accessed through a web browser so that the user can access the platform of the present invention any computing device with access to the Internet.

The present invention is preferably configured to enable the user to create an account that corresponds to the user. As can be seen in FIG. 1 through 12, once the user installs and accesses the software application, the user is prompted to sign into an existing user account or to create a user account. If the user chooses to create a user account, the user is first prompted to select a membership package from a list of membership packages available to the user. The availability of the different membership packages may change according to different factors including, but not limited to, the jurisdiction of where the user resides. Once the user has chosen the desired membership package, the user is prompted to input personal information. The personal information includes, but is not limited to, the user's name, the user's address, contact information, etc. Once the user has entered the user's personal information, the user is prompted to input the automobile information. The automobile information includes, but is not limited to, license plate number, mileage, engine type, last oil change, registration expiration date, safety expiration date, tire size, tire air pressure, oil type, brake fluid type, transmission type, etc. In some embodiments, the present invention may provide means to automatically acquire automobile information from external sources, such as the local vehicle administration department, using available information of the automobile, such as the Vehicle Identification Number (VIN). Once all the information is entered by the user, the data is transmitted from the corresponding computing device to a server for processing and storage. The transmitted data is stored under the user account for future retrieval by the user or other authorized users.

In the preferred embodiment, as can be seen in FIG. 1 through 12, the different membership packages include different priced tiers. All membership packages can have set durations and a set discount that may vary between the different membership packages. For example, a bronze membership tier preferably corresponds to the cheapest membership package that may be priced at a monthly subscription fee of approximately 69 dollars with 95 cents. In the bronze membership, the user is eligible to receive 90 dollars per RAM credit which is purchased in packages, 6 shop visits, 30 RAM credits, and 6 synthetic oil changes. The user is also eligible for engine diagnostic, 27-point inspection, tire check and fill, fluid check and top-off, Air Conditioning (AC) inspection, alignment inspection, shuttle service, credit for set of 4 tires, battery inspection and cleaning, free towing within a certain mileage with a flat fee, free safety inspection, and lube application. Further, a silver membership tier preferably corresponds to the second cheapest membership package that may be priced at a monthly subscription fee of approximately 89 dollars with 95 cents. In the silver membership, the user is eligible to receive 80 dollars per RAM credit which is purchased in packages, 8 shop visits, 40 RAM credits, and 2 synthetic oil changes. The user is also eligible for a free safety check, engine diagnostic, 27-point inspection, fluid check and top-off, alignment inspection, shuttle service, battery inspection and cleaning, free towing, free safety inspection, and lube application. Further, a gold membership tier preferably corresponds to the second most expensive membership package that may be priced at a monthly subscription fee of approximately 129 dollars with 95 cents. In the gold membership, the user is eligible to receive 65 dollars per RAM credit which is purchased in packages, 12 shop visits, 50 RAM credits, and 6 synthetic oil changes. The user is also eligible for a free safety check, rear differential inspection, transmission inspection, loaner vehicle upon availability, used car inspection, engine diagnostic, 27-point inspection, 20% off parts and labor, tire plug or patch, fluid check and top-off, shuttle service, tire inspection and rotation, battery inspection and cleaning, free towing, tire credit for a set of 4 new tires, and lube application. Furthermore, a platinum membership tier preferably corresponds to the most expensive membership package that may be priced at a monthly subscription fee of approximately 250 dollars. In the platinum membership, the user is eligible to receive 50 dollars per RAM credit which is purchased in packages, 6 vehicle round-trips, 20 shop visits, 50 RAM credits, and 6 synthetic oil changes. The user is also eligible for a free safety check, transmission and engine guarantee, transferable benefits, 4 used car inspections, engine diagnostic, 27-point inspection, waterless hand wash, tire plug or patch, fluid check and top-off, shuttle service, tire inspection and rotation, battery inspection and cleaning, free towing, free safety inspection, and lube application. In other embodiments, the present invention may include different membership packages with different features.

In the preferred embodiment, the 27-point inspection includes essential services that are available to all users regardless of the membership package chosen. The 27-point inspection preferably includes, but is not limited to, front-tire wear condition, rear-tire wear condition, drive shaft joint boots, condition of strut, condition of rear shock absorber, condition of front brakes (visual check), condition of rear brakes (visual), brake hydraulic system (fluid and visual check), emergency brake adjustment, clutch adjustment, clutch hydraulic system (repair fluid leak), condition of muffler/exhaust pipes, engine, power steering & transmission oil, condition of drive belts, AC.PS & alternator pulley noise, condition of radiator/coolant, condition of heater & radiator hoses, interior functions & control operations, condition of battery/cables, condition of spark plug/wires, condition of air filter, condition of wiper blades, headlight operation, stop, tail, turn signal, backup, hazard lights, heater/AC operation, restraint system, and other features. In other embodiments, different services can be included in the 27-point inspection.

Once the user has created the user account, the user can access all the features available to the user based on the membership package purchased by the user. As can be seen in FIG. 1 through 12, via the user interface of the corresponding computing device, the user can browse the software application to find the desired feature. For example, the user can browse the features available to the user under the user's membership package, track all the vehicles registered in the user account, or request service. In the preferred embodiment, the services provided by the software application of the present invention include, but are not limited to, requesting roadside assistance, tracking the user's vehicles, or watch a live stream of the repairs. If roadside assistance is requested, the user is prompted to input the issue with the vehicle such as, but not limited to, a flat tire, low fuel, etc. Once selected, the user is presented with updated status of the request. If vehicle tracking is chosen, the user is presented with a list of the vehicles registered under the user account. Once the user chooses a vehicle, the software application displays the location of the vehicle on a visual map as well as the other vehicles if desired. The location services can be implemented by the present invention using in-house location services or by utilizing third-party services. If the watch live feature is selected, the software application displays a live feed of the repair process if a repair process is occurring at the moment. In other embodiments, the present invention may display a recording of the repair process.

Furthermore, the software application can enable the user to book an appointment for service of the desired vehicle. As can be seen in FIG. 1 through 12, the software application may display a calendar on the user interface of the corresponding computing device for the user the user to select a date. The software application may also display a list of available time slots on the selected date from which the user can choose. Once the date and time are selected, the software application of the present invention displays a menu of additional services available to the user based on the membership package purchased by the user. The additional services may also change according to the capabilities of the repair service chosen by the user. For example, the additional services can include, but are not limited to, shop rates, safety check inspection, under carriage inspection, vehicle pickup & delivery, vehicle registration, vehicle diagnostic, vehicle inspection, troubleshooting, etc. Further, the prices of the additional services may present the rates for the different types of vehicles, such as domestic or foreign. Once the appointment details have been entered by the user, the software application of the present invention may present the user with means to prepay the services. Once all the information has been entered, the entered data is transmitted to the chosen service provider for processing. A booking confirmation is sent to the user once the entered data is processed successfully by the user. In addition, the software application of the present invention may provide the user with means to review past services of each vehicle registered under the user account. User profile settings can also be provided to enable the user to update user profile information, methods of payment, or change the membership package.

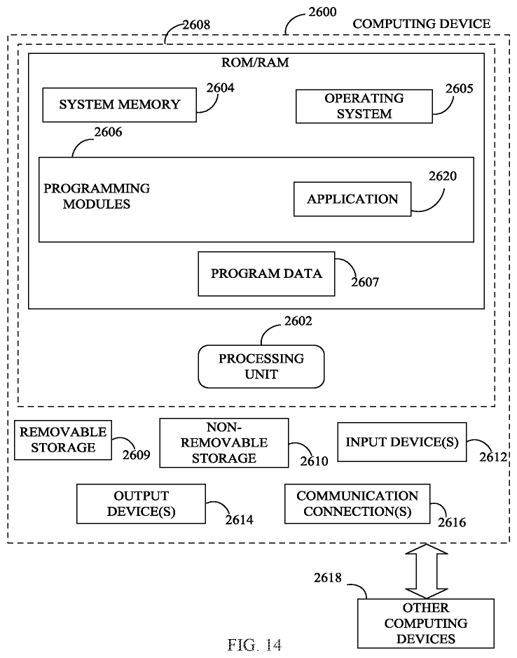

With reference to FIG. 14, a system consistent with an embodiment of the disclosure may include a computing device or cloud service, such as computing device 2600. In a basic configuration, computing device 2600 may include at least one processing unit 2602 and a system memory 2604. Depending on the configuration and type of computing device, system memory 2604 may comprise, but is not limited to, volatile (e.g. random-access memory (RAM)), non-volatile (e.g. read-only memory (ROM)), flash memory, or any combination. System memory 2604 may include operating system 2605, one or more programming modules 2606, and may include a program data 2607. Operating system 2605, for example, may be suitable for controlling computing device 2600's operation. In one embodiment, programming modules 2606 may include image-processing module, machine learning module, etc. Furthermore, embodiments of the disclosure may be practiced in conjunction with a graphics library, other operating systems, or any other application program and is not limited to any particular application or system. This basic configuration is illustrated in FIG. 14 by those components within a dashed line 2608.

Computing device 2600 may have additional features or functionality. For example, computing device 2600 may also include additional data storage devices (removable and/or non-removable) such as, for example, magnetic disks, optical disks, or tape. Such additional storage is illustrated in FIG. 14 by a removable storage 2609 and a non-removable storage 2610. Computer storage media may include volatile and non-volatile, removable and non-removable media implemented in any method or technology for storage of information, such as computer-readable instructions, data structures, program modules, or other data. System memory 2604, removable storage 2609, and non-removable storage 2610 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 2600. Any such computer storage media may be part of device 2600. Computing device 2600 may also have input device(s) 2612 such as a keyboard, a mouse, a pen, a sound input device, a touch input device, a location sensor, a camera, a biometric sensor, etc. Output device(s) 2614 such as a display, speakers, a printer, etc. may also be included. The aforementioned devices are examples and others may be used.

Computing device 2600 may also contain a communication connection 2616 that may allow device 2600 to communicate with other computing devices 2618, such as over a network in a distributed computing environment, for example, an intranet or the Internet. Communication connection 2616 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media. As stated above, a number of program modules and data files may be stored in system memory 2604, including operating system 2605. While executing on processing unit 2602, programming modules 2606 may perform processes including, for example, one or more stages of methods, algorithms, systems, applications, servers, databases as described above. The aforementioned process is an example, and processing unit 2602 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems. Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the invention has been explained in relation to its preferred embodiment, it is to be understood that many other possible modifications and variations can be made without departing from the spirit and scope of the invention.

What is claimed is:

1. A method comprising:
providing a first screen configured to allow a user to sign into an existing user account or to create a user account.
providing a second screen configured to allow user to select a membership package if the user choose to create the user account;
providing a third screen configured to input personal information, in response to the user selecting a membership package;
providing a fourth screen configured to input the automobile information after receiving the personal information;
transmitting to the server, the personal information and the automobile information after receiving the personal information and the automobile information; and
storing the personal information and the automobile information the user account for future retrieval by the user or other authorized users.

2. The method as claimed in claim 1, wherein the personal information includes a user's name, user's address, and contact information.

3. The method as claimed in claim 1, wherein the automobile information includes a license plate number, mileage, engine type, last oil change, registration expiration date, safety expiration date, tire size, tire air pressure, oil type, brake fluid type, and transmission type.

4. The method as claimed in claim 1, further includes a means to automatically acquire automobile information from external sources.

5. The method as claimed in claim 4, wherein the external sources include a local vehicle administration department.

6. At least one non-transitory machine-readable medium including data, which when used by a processor-based server system, causes the processor-based server system to perform instructions that cause the processor-based server system to perform operations comprising:
providing a first screen configured to allow a user to sign into an existing user account or to create a user account.
providing a second screen configured to allow user to select a membership package if the user choose to create the user account;
providing a third screen configured to input personal information, in response to the user selecting a membership package;
providing a fourth screen configured to input the automobile information after receiving the personal information;
transmitting to the server, the personal information and the automobile information after receiving the personal information and the automobile information; and
storing the personal information and the automobile information the user account for future retrieval by the user or other authorized users.

7. The at least one non-transitory machine-readable medium as claimed in claim 6, wherein the personal information includes a user's name, user's address, and contact information.

8. The at least one non-transitory machine-readable medium as claimed in claim 6, wherein the automobile information includes a license plate number, mileage, engine type, last oil change, registration expiration date, safety expiration date, tire size, tire air pressure, oil type, brake fluid type, and transmission type.

9. The at least one non-transitory machine-readable medium as claimed in claim 6, further includes a means to automatically acquire automobile information from external sources.

10. The at least one non-transitory machine-readable medium as claimed in claim 9, wherein the external sources include a local vehicle administration department.

11. A system, the system comprising:
at least one processor; and
a memory including instructions, which when executed on the at least one processor, cause the at least one processor to:
provide a first screen configured to allow a user to sign into an existing user account or to create a user account.
provide a second screen configured to allow user to select a membership package if the user choose to create the user account;
provide a third screen configured to input personal information, in response to the user selecting a membership package;
provide a fourth screen configured to input the automobile information after receiving the personal information;
transmit to the server, the personal information and the automobile information after receiving the personal information and the automobile information; and
store the personal information and the automobile information the user account for future retrieval by the user or other authorized users.

12. The system as claimed in claim 11, wherein the personal information includes a user's name, user's address, and contact information.

13. The system as claimed in claim 11, wherein the automobile information includes a license plate number, mileage, engine type, last oil change, registration expiration date, safety expiration date, tire size, tire air pressure, oil type, brake fluid type, and transmission type.

14. The system as claimed in claim 11, further includes a means to automatically acquire automobile information from external sources.

15. The system as claimed in claim 14, wherein the external sources include a local vehicle administration department.
